(19) United States
(12) Patent Application Publication
(10) Pub. No.: US 2008/0184547 A1
(43) Pub. Date: Aug. 7, 2008

(54) Textile display

(76) Inventors: Junior Gupta, Tucker, GA (US); Michael W. Falkenhagen, Douglasville, GA (US)

Correspondence Address: SEYFARTH SHAW LLP, 131 S. DEARBORN ST., SUITE 2400, CHICAGO, IL, 60603-5803, US

(21) Appl. No.: 11/702,718

(22) Filed: Feb. 6, 2007

(51) Int. Cl. B32B 3/00

(52) U.S. Cl. 29/462; 428/53

(57) ABSTRACT

A textile display including a frame including a first vertical support and a second vertical support, at least one base support extending from an end of each of the first and second vertical supports and at least one side panel removably attached to the frame.

### BACKGROUND

Displays such as display cases are used to display different sale items to customers. Such displays are used to display different types of textiles such as drapes, tapestries, carpets or rugs. In carpet stores, customers will look through several different carpets to assist them in choosing a carpet for their home. The carpets are typically displayed on racks. In this way, the customer can flip through a number of carpets to determine which one they like. Similarly, a person who has hardwood floors, tile floors or other non-carpeted floors, may look for a throw rug, oriental rug, or other type of area rug to put on their floor. Area rugs come in all different sizes, shapes and colors. Accordingly, there are a number of different ways to display these rugs. One way is to stack the rugs on the floor and have a customer flip through them to see the different styles and colors of the rugs. However, this becomes difficult with larger rugs that are heavy and difficult to lift and move.

Larger rugs are also hung on rug displays or rug racks. The rug racks are modular units which are assembled and include bars or similar supports which are used to hang the rugs so that a customer can see the size, shape and color of the rug. One way to display area rugs, and especially large area rugs, is to use a metal rack which is mounted to a wall. These racks have several horizontal bars which are hinged and connected to a wall mount structure. Typically, a single rug is folded over or hung over each bar. A customer can grab the hanging rung and pivot or rotate it away from an adjacent hanging rug to view each rug on the display.

Additionally, there are free-standing displays which can be assembled and set up in any part of a showroom. For example, U.S. Pat. No. 3,965,583 describes a display rack that displays rectangular carpet samples in an overlapping arrangement on a frame so that each carpet sample can be viewed simultaneously. In another example, U.S. Pat. No. 5,452,809 describes a free-standing structure for display rugs which can be pivoted so that a person can view the rugs. The display also includes a pair of frame structures for displaying rolled-up carpets or rugs. These displays, however, require fasteners such as bolts or screws to join the different supports together. Therefore, assembly and disassembly of such displays takes a significant amount of time and effort.

Additionally, most displays are unattractive because the framework and other components of the displays are exposed. Such unattractive displays take away from the attractiveness of the items being displayed which can decrease sales.

Accordingly, there is a need for an improved textile display which overcomes the above problems.

### SUMMARY

One embodiment of the present invention is to provide a textile display including a frame having a first vertical support and a second vertical support, at least one base support extending from an end of each of the first and second vertical supports and at least one side panel removably attached to the frame.

In an embodiment, at least a portion of the side panel is solid.

In an embodiment, the side panel and the frame form an angle, where the angle is less than or equal to 180 degrees.

In an embodiment, the side panel and the frame form an angle, where the angle is greater than 180 degrees.

In an embodiment, the textile display includes a trim member attached to the side panel.

In an embodiment, the textile display includes a first and second side panel respectively attached to the first and second vertical supports of the frame.

In an embodiment, the textile display includes a first brace attached to the first vertical support and to a first base support extending from the first vertical support, and a second brace attached to the second vertical support and a second base support extending from the second vertical support.

Another embodiment of the textile display includes a frame including a first support and a second support, a first side panel attachable to the first support, a second side panel attachable to the second support and at least one wedge attached to each of the first and second side panels. The first and second side panels are respectively attached to the first and second supports by frictionally engaging the wedge of the first side panel with the first support and the wedge of the second side panel with the second support.

In an embodiment, a length of the wedge attached to at least one of the first and second side panels is less than a length of at least one of the first and second side panels.

In an embodiment, a length of the wedge attached to at least one of the first and second side panels is equal to a length of at least one of the first and second side panels.

In an embodiment, the textile display includes a plurality of wedges attached to at least one of the first and second side panels.

A further embodiment of the present invention provides a method of assembling a textile display for displaying one or more textile products. The method includes providing a frame including a first vertical support and a second vertical support, attaching at least one base support to an end of each of the first and second vertical supports and removably attaching at least one side panel to the frame.

In an embodiment, at least a portion of the side panel is solid.

In an embodiment, removably attaching the at least one base support includes forming an angle between the side panel and the frame.

In an embodiment, the angle is less than or equal to 180 degrees.

In an embodiment, the angle is greater than 180 degrees.

In an embodiment, the method includes attaching a trim member to the side panel.

In an embodiment, the method includes respectively attaching a first and second base support to the first and second vertical supports of the frame.

In an embodiment, the method includes attaching a first brace to the first vertical support and to a first base support, and attaching a second brace to the second vertical support and a second base support.

Accordingly, an advantage of the present invention is to provide a textile display that includes at least one solid side wall.

Another advantage of the present invention is to provide an textile display which is attractive to customers.

A further advantage of the present invention is to provide a textile display which is easy to assemble and disassemble.

Another advantage is to provide a textile display which does not require connectors such as screws and bolts.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is an exploded perspective view of an embodiment of the textile display of the present invention.

FIG. 2 is a perspective view of the textile display of FIG. 1 where the frame and side panels are assembled.

FIG. 3a is an exploded perspective view of an embodiment of a side panel.

FIG. 3b is a perspective view of an assembled side panel.

FIG. 4 is a partial perspective view of a side panel positioned adjacent to one side of the frame.

FIG. 5 is a partial top view of a side panel attached to a side of the frame.

FIG. 6a is a side view of FIG. 5 illustrating the side panel attached to the frame.

FIG. 6b is a front view of FIG. 5.

FIG. 6c is a rear side view of FIG. 5 where the side panel is attached to the frame.

FIG. 7 is a perspective view of a side panel having a wedge that is engaged with a side of the frame.

FIG. 8 is a front view of the embodiment of FIG. 7.

FIG. 9 is a cross-section view taken substantially along line 9-9 in FIG. 8.

### DETAILED DESCRIPTION

The present invention is directed generally to a display, and more specifically, to a textile display for displaying one or more textiles such as one or more rugs.

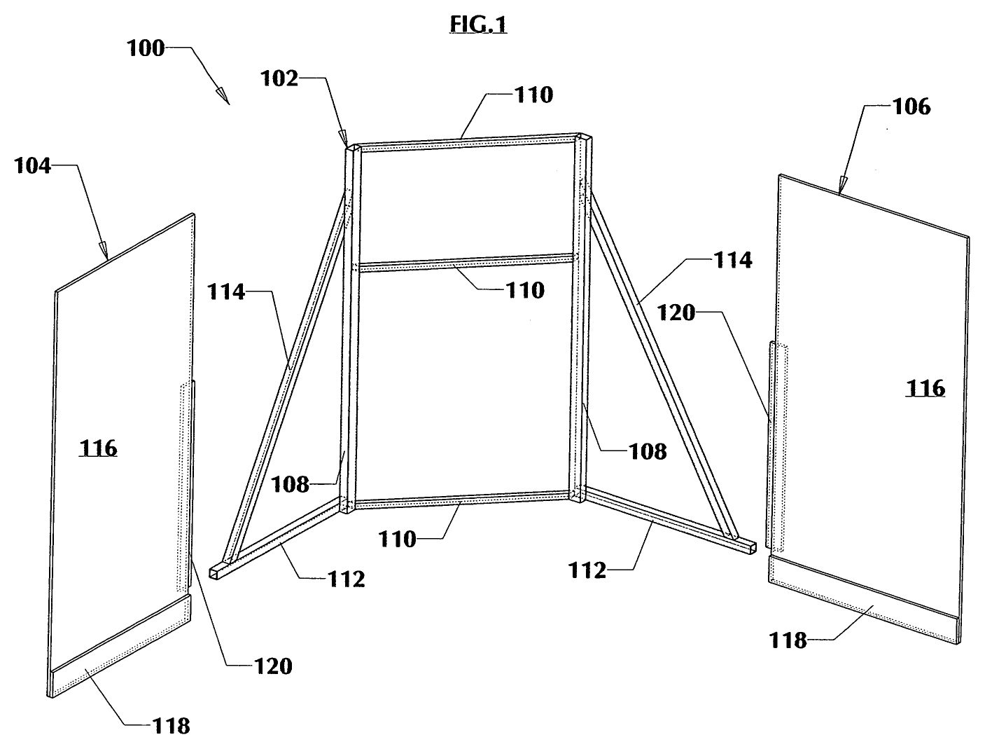

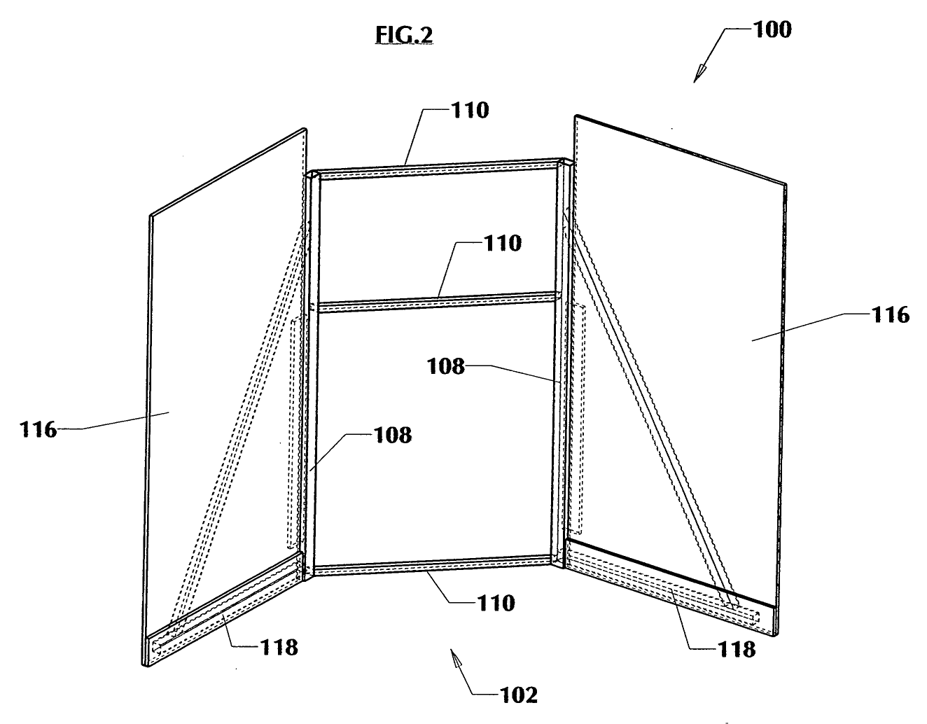

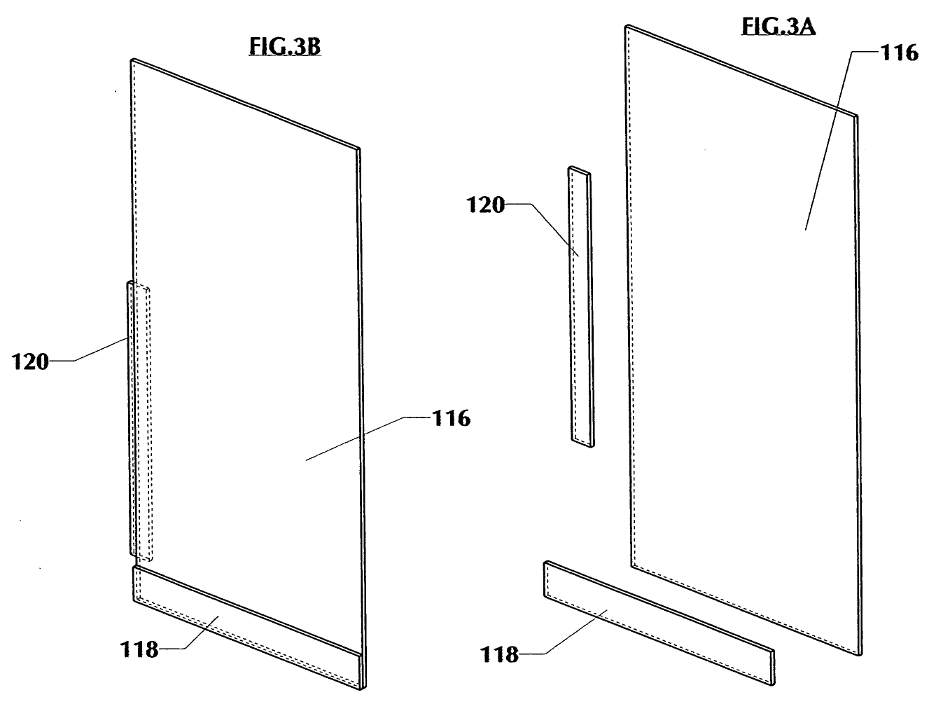

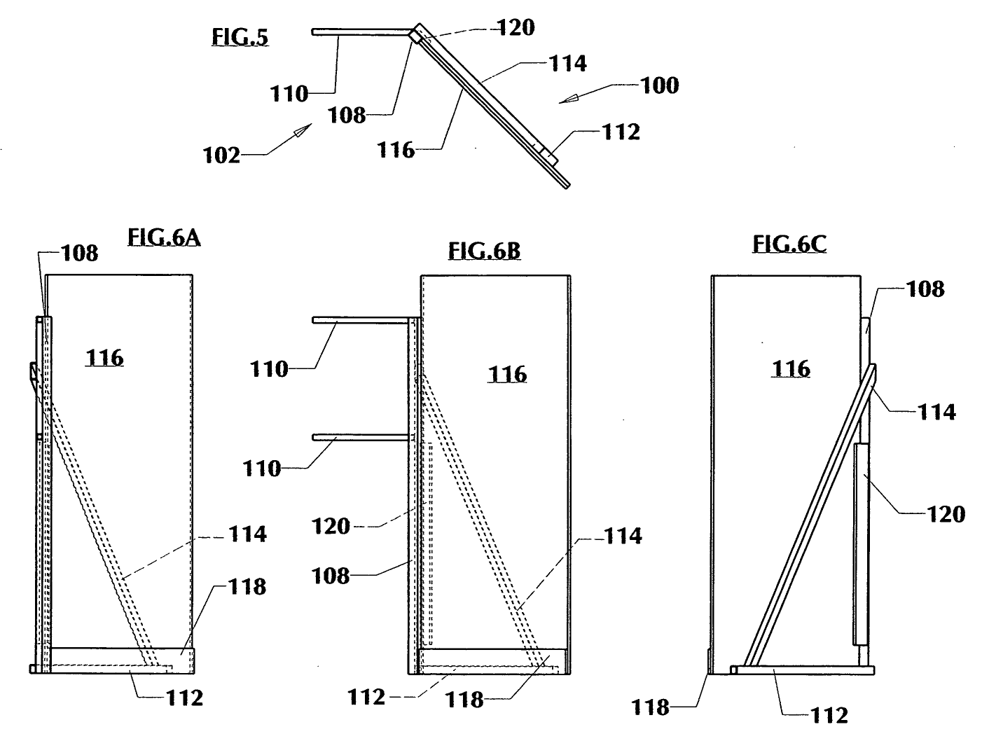

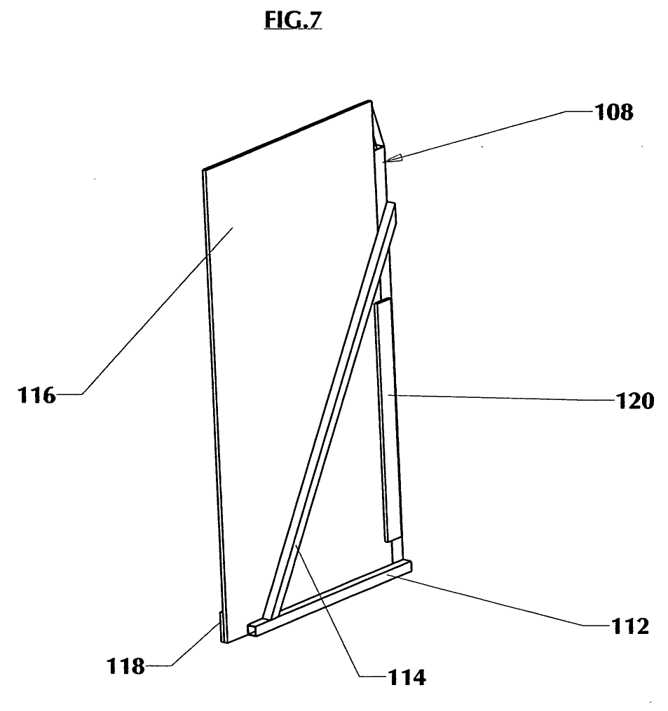

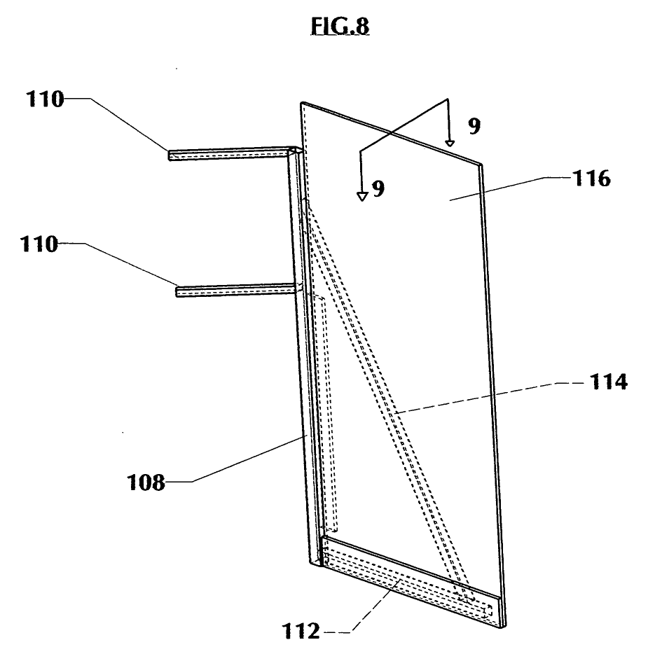

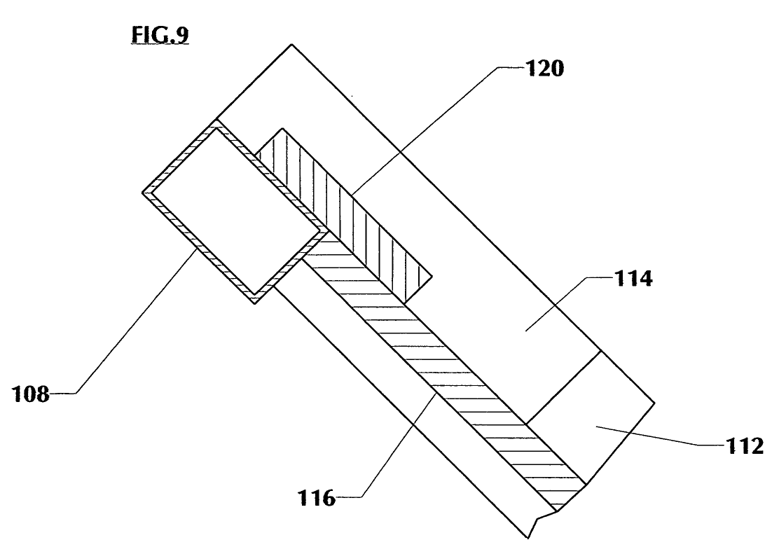

Referring to FIGS. 1-9, the textile display 100 includes a frame 102 which is constructed to stand freely on an underlying surface and a first side wall or side panel 116 and a second side panel 117 attached to the frame. In the illustrated embodiment, the frame 102 includes two upright or vertical supports 108 that are spaced-apart and joined together by horizontal supports 110. The horizontal supports 110 include two ends, one of which is connected to one of the vertical supports 108 and the other end is connected to the other vertical support 108. The horizontal supports 110 provide rigidity, strength and stability to the frame. Two base supports are connected to the lower ends of the vertical supports and each extend at an angle away from the vertical supports 108. The angle is formed between each of the base supports and the bottom horizontal support of the frame. In an embodiment, the angle is less than or equal to 180 degrees. In another embodiment, the angle is greater than 180 degrees. It should be appreciated that the angle may be any suitable angle. It should also be appreciated that the angle formed between each base support and the bottom horizontal support of the frame may be the same or different. Furthermore, it should also be appreciated that the textile display may include a plurality of horizontal supports and base supports.

A brace support or brace 114 is connected from the top end of the vertical supports 108 to a designated position on the base supports 112. As shown in FIG. 1, the braces 114 are connected at one end to the top of the vertical supports 108 and at the other end to the base supports 112 at a position that is a designated distance from the vertical supports 108. The braces 114 provide stability to the vertical supports 108. In an embodiment, the braces are attached to the vertical and base supports using connectors such as screws, bolts or any other suitable connectors.

Each side panel 116,117 is attached to the frame 102 and are generally rectangular members. At least a portion of each of the side panels is solid or made of a solid material. It should be appreciated that the side panels 116,117 may be any suitable size or shape or may be made of any suitable material. The solid side panels help to hide the frame and enhance the appearance and attractiveness of the textile display.

In an embodiment, at least one wedge 120 is attached to an edge of the side panels 116,117. The wedge 120 defines an open-ended channel which extends the length of the wedge and enables the wedge to be frictionally engaged with the edge of the side panels 116,117. It should be appreciated that the wedge 120 performs a wedging function and is not restricted to being a “wedge” shape. In this regard, it should be appreciated that the wedge may be any suitable size or shape. It should also be appreciated that one wedge or a plurality of wedges may be used to secure a side panel or other member to the frame. In the illustrated embodiment, the wedge 120 has a length which is less than the length of the side panels 116,117. It should be appreciated that the wedge may be the same length as the length of the side panel, or any suitable length. It should be appreciated that the wedge is not the only method of attaching the side panels to the frame. Connectors such as screws, bolts, Velcro® or any other suitable connectors or a suitable adhesive such as glue, may be used to attach one or both side panels to the frame.

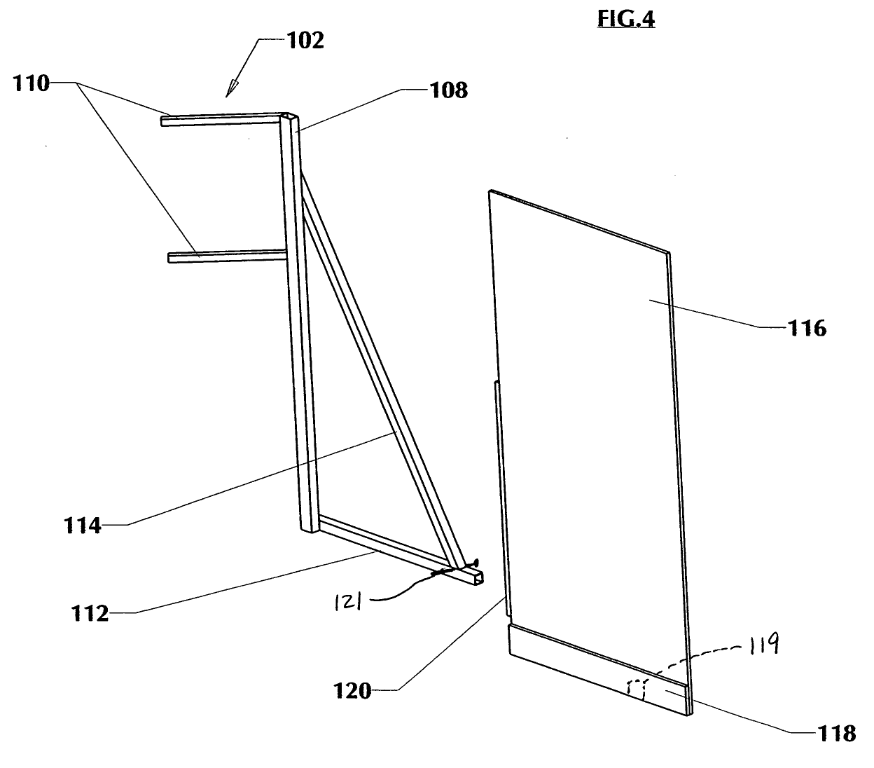

In an embodiment, a side panel trim member 118 is attached to the bottom edge of the side panels 116,117. The trim member 118 is attached to the side panel in the during the assembly of the side panel. In another embodiment, the trim member 118 is a separate component which is attached to the side panel after the side panel is assembled. The trim member 118 is attached to one side or surface of the side panel. Specifically as shown in FIG. 4, the trim member 118 defines a recess 119 in one side of the trim member to cover or hide a connector 121, such as a bolt or screw, which secures the brace support 114 to the base support 112. The recess 119 is not visible from the front of the display. The trim member 118 therefore enhances the appearance of the display by hiding unsightly connectors used to hold the display together.

In an embodiment, each side panel is positioned adjacent to a side of the frame 102. The side panels 116,117 are each angled inwardly with respect to the corresponding vertical supports 108 so that the wedges 120 on the side panels move or slide into engagement with the vertical supports of the frame. Specifically, the wedge 120 attached to each of the side panels 116, 117 slides behind the corresponding vertical support 108. The frictional engagement between the wedge 120 and the vertical support 108 securely holds the side panels 116,117 on the frame 102. To remove a side panel 116, a user simply applies a designated force to pull the side panels 116,117 away from the frame 102 to release the side panels from the frame. The construction or assembly of the frame and side panels that form the textile display 100 enables the display to be quickly and easily set up and/or disassembled. Therefore, substantial time and effort is saved. Also, the textile display has a more appealing or attractive appearance where photographs or other displays can be mounted directly to the side panels of the display to indicate sale items or other promotions as well as display different textiles.

In other embodiments, the frame and side panels of the display are secured together using connectors such as screws, bolts, Velcro®, adhesives or any other suitable connectors or connection methods.

In the above embodiments, the parts or components of the rug display are made of metal. It should be appreciated that the rug display may be made of metal, wood or any other suitable material or combination of materials.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A textile display comprising:
a frame including a first vertical support and a second vertical support;
at least one base support extending from an end of each of said first and second vertical supports; and
at least one side panel removably attached to said frame.

2. The textile display of claim 1, wherein at least a portion of said side panel is solid.

3. The textile display of claim 1, wherein said side panel and said frame form an angle, and wherein said angle is less than or equal to 180 degrees.

4. The textile display of claim 1, wherein said side panel and said frame form an angle, and wherein said angle is greater than 180 degrees.

5. The textile display of claim 1, which includes a trim member attached to said side panel.

6. The textile display of claim 1, which includes a first and second side panel respectively attached to said first and second vertical supports of said frame.

7. The textile display of claim 1, which includes a first brace attached to said first vertical support and to a first base support extending from said first vertical support, and a second brace attached to said second vertical support and a second base support extending from said second vertical support.

8. A textile display comprising:
a frame including a first support and a second support;
a first side panel attachable to the first support;
a second side panel attachable to the second support; and
at least one wedge attached to each of the first and second side panels, the first and second side panels being respectively attached to the first and second supports by frictionally engaging the wedge of the first side panel with the first support and the wedge of the second side panel with the second support.

9. The textile display of claim 8, wherein a length of the wedge attached to at least one of the first and second side panels is less than a length of at least one of the first and second side panels.

10. The textile display of claim 8, wherein a length of the wedge attached to at least one of the first and second side panels is equal to a length of at least one of the first and second side panels.

11. The textile display of claim 8, which includes a plurality of wedges attached to at least one of the first and second side panels.

12. A method of assembling a textile display for displaying one or more textile products, the method comprising:
providing a frame including a first vertical support and a second vertical support;
attaching at least one base support to an end of each of said first and second vertical supports; and
removably attaching at least one side panel to said frame.

13. The method of claim 12, wherein at least a portion of said side panel is solid.

14. The method of claim 12, wherein removably attaching said at least one base support includes forming an angle between the side panel and said frame.

15. The method of claim 14, wherein said angle is less than or equal to 180 degrees.

16. The method of claim 14, wherein said angle is greater than 180 degrees.

17. The method of claim 12, which includes attaching a trim member to said side panel.

18. The method of claim 12, which includes respectively attaching a first and second base support to the first and second vertical supports of the frame.

19. The method of claim 12, which includes attaching a first brace to the first vertical support and to a first base support, and attaching a second brace to the second vertical support and a second base support.
